(19) United States
(12) Patent Application Publication
(10) Pub. No.: US 2007/0144813 A1
(43) Pub. Date: Jun. 28, 2007

(54) Pump hybid motor

(76) Inventor: Yoshioki Tomoyasu, Fujisawa-shi (JP)

Correspondence Address: Yoshioki Tomoyasu, 21-22, Mirokuji 3-chome, Fujisawa-shi, Kanagawa-ken, 251-0016, JP

(21) Appl. No.: 11/313,465

(22) Filed: Dec. 22, 2005

(51) Int. Cl. B60K 17/00

(52) U.S. Cl. 180/305

(57) ABSTRACT

The invention is directed to develop for the higher performance of the motor by means of incorporating the function of the pump to circulate the fluid through conduit laid around the housing in rotating operation with a single shaft in common use among original motor, pump and another impeller equipped therein, thus enabling to cool the high temperature inside of the motor by means of exposing to fresh air or cooler to keep high torque and to augment the torque produced by the rotating force caused by the difference between two areas of the vanes of two impellers accommodated within the same chamber according to Pascal's principle, thus enabling to put the electric vehicle to an actual use by the method that single unit or so is easily possible to replace the used battery with charged battery with almost same trouble in case of supplying fuels to the engine motor cars in continuous driving operation.

### FIELD OF THE INVENTION

This invention is generally directed to developing for the higher performance of the motor to generate the various kinds of machines and electric appliances operations with less consumption of the fuels as well as electricity. Especially, in case where the motor is applied to the driving force of the electric vehicle, much higher power of the motor is required.

### BACKGROUND OF THE INVENTION

The present invention is related to the technology which is directed for developing for higher efficiency of the motor to save fuels and to generate strong power to an extent that it is possible to apply to the electric vehicle which have been suffered with small driving force available in contrary to the weights involved. Thus heavy consumtion for fuels and subsequent pollution problem have occurred.

### Description of the Prior Art

The prior art of the existent motor is apt to induce heat which cause to reduce the torque for generating for machines as well as appliances operation due to the fact that the heat is most liable to offer more resistance to rotating shafts, thus causing for heavy consumption for the natural resouces as well as pollutions.

### SAMMARY OF THE INVENTION

The present invention is generally directed to develop for the higher performance of the motor by means of incorporating a pump to a mechanism of a motor designed to augmentate the torque of the shaft by dint of rotating force generated by fluid fed into the impeller with wider breadth of the vane than that of the pump fixed on the identical shaft to spout the fluid through the outlet of the housing connected either hose or pipe to be circulated fluid laid around the same housing. Thus the wider breadth of the vane of the impeller fixed on the identical shaft cause to add the additional force onto the rotating shaft which is originally operated by the electromagnet same as the common motor operates according to Pascal's principle just like power steerling in the motor car. In addition, the temperature heated in operation just as the conventional motor is to be cooled by a cooler such as rediator of the motor car in the course of circulating through either hose or pipe around the housing. Therefore, the present invention is applicable to the electric vehicle which is required to be light weight and strong driving force with view to putting it to the practical use.

### BRIEF DISCRIPTION OF THE DRAWING

FIG. 1: The cross sectional view of the pump hybrid motor based on this invention as an example.

### DETAILED DESCRIPTION OF THE INVENTION

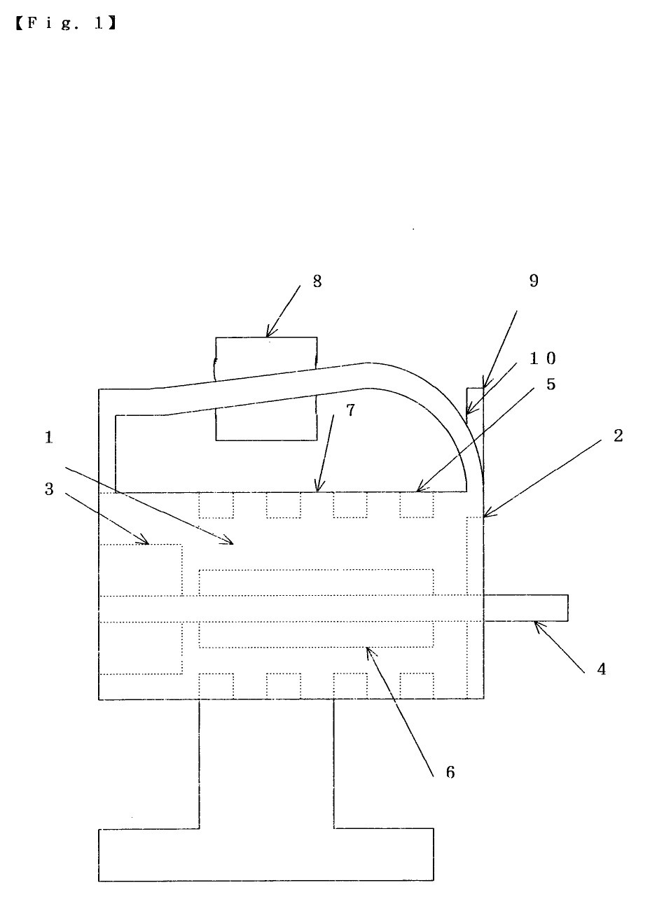

As shown FIG. 1, the present invention is related to the motor incorporating pump (2) to circulated fluid (1) through either hose or pipe (10) laid around the housing (7) designed to operate the single shaft (4) in common use among the pump, motor and another impeller to cool the heat directly exposed to fresh air or the cooler (8) which is generated in operation,otherwise the torque of the motor would be noticeably deteriorated. Another advantage of the pump hybrid motor is designed to augment the torque of the original motor produced by the stator (5) and the rotor (6) with the rotating force by the fluid (1) fed through either hose or pipe (10) laid around the housing (7) into the wider area of the vane (3) inside the chamber of the motor than that of pump (2) capable of adjusting for the level of the fluid by the fluid inlet (9) magnifying at the ratio of respective area of the both vanes (2) and (3) according to Pascal's principle just like the principle of the power steering in the motor car industry. In case where the pump hybrid motor is applied to the electric motor, the pump hybrid motor is most likely to provide high driving power almost equivalent to those of engines of the motor car with only one unit as mentioned before, thus enabling to replace used battery with charged battery with almost trouble to feed fuels to other engine motor cars causing manycproblems such as pollution, heavy consumption of fuels and the like at lower costs.

1. The pump hybrid motor is designed to incorporate function of the pump (2) into the motor to circulate the fluid (1) through either hose or pipe (10) laid around the housing (7) from the inside to the outside, thus enabling to directly cool the heat generated in operation by means of either cooler (8) or fresh air attributable to the reason why the high temperature cause to lower the torque involved.

2. As hereinbefore set forth in clause (1) the fluid (1) fed into another vane (3) of the impeller of which shaft (4) is identical with the motor as well as the pump (2) is designed to augment the torque generated by stronger rotating force produced with wider space of the vane (3) than that of the pump (2) according to Pascal's principle.

3. The pump hybrid motor is applied to the electric motor car with the strong driving force enough to drive it with only one unit as the same power of the other engine of the motor car due to the reason as hereinbefore mentioned, furthermore, in case where only one unit or so of the pump hybrid motor is loaded, it is possible to be easily replaced with small number of batteries immediately in saving trouble at feeding fuels for other engine car in continuous driving operation.
